(19) United States
(12) Patent Application Publication
(10) Pub. No.: US 2012/0101851 A1
(43) Pub. Date: Apr. 26, 2012

(54) SYSTEMS FOR OFFERING AND/OR PROVIDING ATTORNEYS' FEES INSURANCE

(76) Inventor: Kevin B. Martin, Los Angeles, CA (US)

(21) Appl. No.: 12/909,208

(22) Filed: Oct. 21, 2010

(51) Int. Cl. G06Q 40/00

(52) U.S. Cl. 705/4

(57) ABSTRACT

The present invention provides an attorneys' fees policy system, comprising means for importing case leads and disseminating the leads to a sales representative, means for receiving application data of the insured party into an attorneys' fees insurance database and uploading the application, an attorneys' fee contract and a related formal legal complaint, means for requesting underwriting approval of the attorneys' fee policy application, means for placing the attorneys' fee policy into active status if underwriting is approved, and means for receiving data on the approved attorneys' fee policy and initiating a policy issuance process.

### TECHNICAL FIELD

The invention relates generally to insurance products, and more particularly to systems for offering and/or providing attorneys' fees insurance.

### DESCRIPTION OF THE RELATED ART

In practically every system of governance, there exists a judicial system for handling disputes between parties. In the United States, as well as in many other countries, complex sets of rules govern judicial procedures and substantive law. As a result, it has become almost a necessity that litigants obtain the advice and guidance of legal counsel when participating in the judicial process. Retaining the services of a lawyer, however, is a costly endeavor. Accordingly, the cost of legal services must be considered when evaluating how to resolve a dispute.

In Britain and elsewhere within Europe, the legal system is such that the losing party in a lawsuit must pay the attorneys' fees and costs of the prevailing party. For the purposes of this description, attorneys' fees will refer to both the attorneys' fees and also to any costs that are awarded. A consequence of this practice is that the wealthy are better able to afford the expenses of litigation. Lower and middle class litigants generally cannot afford to retain their own counsel, let alone pay for an adversary's attorneys' fees in the event they are required to do so. These litigants are further deterred from litigation by aggressive litigation tactics which can make litigation too expensive. Obviously, this type of legal system in which the losing party pays for the prevailing party's attorneys' fees creates a great imbalance of power between the classes.

In legal systems—such as in Britain and in Europe—where the prevailing party recovers its attorneys' fees from the losing party, litigants purchase attorneys' fees and legal costs insurance to cover their own attorneys' fees, as well as to insure against the risk of potentially paying their adversary's attorneys' fees (the “European Policy”). The European Policy offers term coverage, is purchased annually or on some other periodic basis, and only covers disputes arising during the term of the coverage. The European Policy generally covers most disputes but may exclude certain types of claims, such as intellectual property disputes and disputes involving certain types of contracts. As expected, the policy also excludes disputes in existence prior to the purchase of the insurance. In exchange for receiving the benefits under the European Policy, a litigant grants the insurer greater discretion and control over how a dispute is litigated. For instance, the insurer can require the insured to participate in alternative dispute resolution, to take reasonable steps to avoid or to minimize a claim under the policy, and to settle the disputes.

Another form of litigation insurance that is available in Europe is After The Event (ATE) insurance. In some cases, ATE insurance covers the insured's liability for their opponent's legal costs, whether that liability arises from a defeat at trial, discontinuance, or another outcome (e.g., the failure to better a Part 36 offer). In addition, the insured may opt to insure their own disbursements, including attorneys' fees. However, ATE insurance expressly will not cover the insured's own disbursements on an interim basis, but only at the conclusion of the case in the event of an unsuccessful outcome. In England & Wales, an ATE insurance premium may be recoverable by the successful litigant as part of their costs from the paying party. Premiums are typically available on a deferred and self-insured (or contingent upon success) basis, such that the premium is only payable at the conclusion of the case, and only if the case is successful. If the case is unsuccessful, a claim can be made under the policy for the insured's legal costs and the insurer does not collect a premium. ATE insurers are therefore effectively speculating on the case succeeding in order to earn any income. ATE insurance premiums commonly have a built-in premium discount factor. This means that the premium effectively increases, in line with the insurer's financial risk, the closer the case gets to trial. This also means that the premium remains broadly proportionate to the cost exposure and provides the opponent with the incentive to settle the case early in order to face a reduced liability for the premium.

Against this backdrop, the legal system in America follows a far different approach. The philosophy behind the American system is the notion that every party has the right to his/her day in court and that this right should not be unduly hindered by the fear of reimbursing one's adversary if a party should lose. Rather than requiring that the losing party cover the prevailing party's attorneys' fees, each party in a dispute within the United States generally pays for their own attorneys' fees, regardless of the results (the “American Rule”). By not penalizing the losing party with the extra cost of the opposing party's attorneys' fees, this type of legal system is considered more open to all classes of society.

One drawback to the American legal system is that parties are often forced to litigate frivolous matters. In order to deter frivolous litigation, federal statutes have been promulgated and patterns of practice have developed that modify the American Rule and permit a prevailing party in a litigation to recover attorneys' fees from the losing party. For instance, in 1975, approximately 30 federal statutes existed which allowed the prevailing party to recover their attorneys' fees. By the early 1980s, the number of statutes had increased to approximately 150. In addition to statutes, many contracts provide that if a dispute between the contracting parties arises under the contract, the prevailing party in the dispute will recover his/her attorneys' fees from the losing party. Thus, a measurable trend has occurred in the American legal system away from the American Rule.

Despite this trend, the default and majority rule within the United States remains that each party pays for their own attorneys' fees. In the cases where the exception to the American Rule applies, the losing party is in the same position as European litigants. Ho ever, unlike European litigants, American litigants are at a measurable disadvantage because there is no insurance mechanism in the United States to allay the risk of paying an adversary's attorneys' fees. As mentioned above, the European Policy provides coverage over a term and covers attorneys' fees arising from disputes during that term. Not only is the European Policy not available in the United States, it would not address the particular needs of American litigants. In the first instance, because paying an adversary's attorneys' fees is the exception and not the rule in the United States, it makes little sense to purchase such a policy on a term basis. In any event, under the European Policy, once an American litigant was faced with a dispute requiring coverage, the party would be unable to purchase the insurance because his claim would be considered a “pre-existing” legal dispute. Such a litigant would require some form of ATE insurance to cover the litigation under these circumstances. However, ATE insurance is not currently available outside of Europe, the premiums differ based upon the success or lack thereof) of the insured, and the insured typically loses control over strategic decisions such as the selection legal counsel and settlement decisions.

### BRIEF SUMMARY OF EMBODIMENTS OF THE INVENTION

One embodiment of the invention is directed toward an attorneys' fees policy system, comprising: means for importing case leads and disseminating the leads to a sales representative; means for receiving application data of the insured party into an attorneys' fees insurance database and uploading the application, an attorneys' fee contract and a related formal legal complaint; means for requesting underwriting approval of the attorneys' fee policy application; means for placing the attorneys' fee policy into active status if underwriting is approved; and means for receiving data on the approved attorneys' fee policy and initiating a policy issuance process.

In some embodiments of the invention, the insured party provides the sales representative with the completed attorneys' fees policy application, a check, a surplus lines affidavit, the signed attorneys' fee contract and the related legal complaint. The sales representative then fills out a checklist confirming that all required items have been received. The sales representative converts the case lead to upending policy once a sale is made and a unique policy ID is created, and the policy is placed into pending approval status while awaiting underwriting approval.

In one exemplary implementation, the policy is purchased within a predetermined number of days after the filing of the related formal legal complaint, wherein the policy provides a fixed premium with a fixed amount of coverage and does not require any review of the complaint or any other document. In another exemplary implementation, the policy is purchased after the initiation of the related legal complaint, wherein the policy is offered after a review of the related legal complaint in order to make a determination as to whether it is financially viable to insure the risk and, if so, at what premium. In a further exemplary implementation, the policy is purchased before the inception of a related legal complaint, wherein the policy is offered at a reduced premium with a fixed amount of coverage. In yet another exemplary implementation, the policy comprises a shelf policy offered in a package at a reduced premium for an attorney to provide insurance to clients.

In various embodiments of the invention, the policy may be priced based on factors including, but not limited to: type of product in which the policy is embodied; type of legal event; legal counsel selected by the insured; type of contract; amount of coverage desired; manner in which the policy is marketed; litigation track record of the insured and its adversary; frequency by which attorneys' fees are awarded in a particular location and for a particular final adjudicator; average time to judgment; and frequency by which the insured and its adversary settle cases.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a flowchart illustrating an attorneys' fees insurance process flow overview, in accordance with the principles of the invention.

FIG. 2 is a flowchart illustrating a more detailed attorneys' fees insurance process flow, in accordance with the principles of the invention.

FIG. 3 illustrates a case lead control web page in accordance with the principles of the invention.

FIG. 4 illustrates an exemplary case lead form web page in accordance with the principles of the invention.

FIG. 5 illustrates an exemplary law firm control web page in accordance with the principles of the invention.

FIG. 6 illustrates an exemplary attorney form web page in accordance with the principles of the invention.

FIG. 7 illustrates an exemplary dashboard web page in accordance with the principles of the invention.

FIG. 8 is a diagram illustrating an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The invention relates generally to systems for offering attorneys' fees insurance within the particular framework of the American legal system. In one embodiment of the invention, the insurance provides coverage after the occurrence of an event, such as the initiation of a lawsuit or a dispute over a contract. Here, the invention covers an adversary's attorneys' fees incurred in a legal dispute between the parties. Under the policy, an adjudicator may be a judge, magistrate, arbitrator, or an administrative law judge who is able to enter a final order. This final order is one that is legally binding on the parties and triggers a payment under the policy only when the final order includes a requirement that the insured pay for the adversary's attorneys' fees and when either: (1) an appeal of the fee award is exhausted or (2) the time to appeal the fee award has expired.

As mentioned above, the insurance is offered after the occurrence of an event. This event may be a contract which contains “attorney fee shifting provisions” specifying that the prevailing party in a lawsuit arising out of the contract will recover the costs of the attorneys' fees from the losing party. The contract may be any type of contract between two or more parties, including but not limited to partnership agreements, leases, real estate sales contracts, settlement agreements, indemnity agreements, invoices or Bills Of Ladings, declarations of restrictions in CCRs, construction contracts, note guarantees, insurance policies, mechanics liens, safe deposit box agreements, and arbitration agreements. In addition to contractual fee shifting provisions, Federal or State statutes or regulations provide for fee shifting. The insurance is intended to cover any type of event by which the prevailing party recovers his/her attorneys' fees from the losing party.

The insurance may be purchased in connection with various kinds of legal proceedings. One type of proceeding may be litigation in a State or Federal court between the insured and another party. In this example, the insurance would cover the cost of the adversary's attorneys' fees for the losing party incurred during the litigation period. The dispute between the insured and another party may be handled outside of court, such as through arbitration. The insurance may therefore encompass the adversary's attorneys' fees incurred by the losing party as a result of some arbitration. As another example, the proceeding may be one before a government agency, such as the Food and Drug Administration, International Trade Commission, Securities and Exchange Commission, etc.

The systems of providing insurance according to the invention satisfy a unique need within the American market. While some policies may provide insurance coverage for a party's own attorneys' fees, presently, no insurance in the United States covers the costs of an adversary's attorneys' fees. Because these costs can be high, individuals and small to medium businesses will find the insurance systems according to the invention to be especially attractive. These consumers are less litigious and are more likely to seek insurance in order to minimize their overall financial exposure. While each party normally pays for their own attorneys' fees, the risk of paying an adversary's attorneys' fees is substantial enough to warrant the insurance.

According to the Center for State Courts, there are approximately 4,500,000 breach of contract cases filed in U.S. Federal and State courts every year. In fact, contract cases have accounted for approximately 75 percent of all civil filings excluding small claims. The high number of contract cases coupled with the trend toward including “attorney fee shifting provisions” presents a real and measurable risk that a party may be forced to pay for their adversary's attorneys' fees.

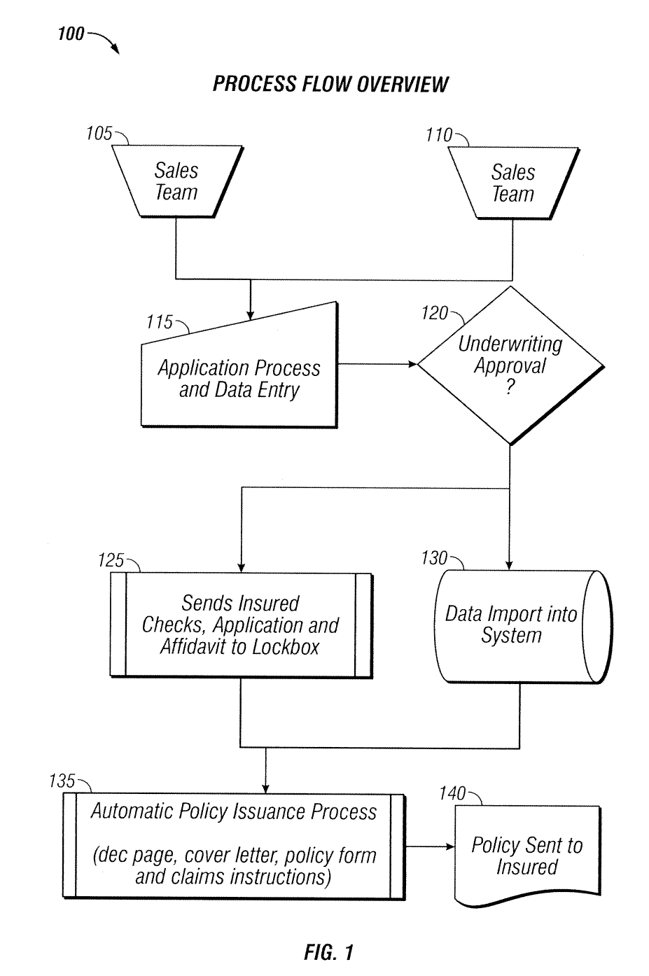

Referring to FIG. 1, an attorneys fees insurance process flow overview 100 is illustrated. In particular, operations 105 and 110 involve insurance sales teams, whereby a sales representative following a case lead meets with the to be insured party. Operation 115 includes the application process and data entry. Specifically, this operation may entail (i) the sales representative receiving the attorneys' fees insurance application, check, surplus lines affidavit, contract and complaint, (ii) filling out a checklist confirming that all required items have been received, (iii) converting the case lead to a pending policy, and/or (iv) creating a unique policy ID. In some embodiments, operation 115 further comprises the sales representative entering the insured party's application data into an attorneys' fees insurance database and uploading the application, contract and complaint, as well as filling out a checklist confirming that all necessary data is entered. The pending policy is then put into underwriting status.

With further reference to FIG. 1, operation 120 involves underwriting approval. Specifically, underwriting is performed on data in the system (including OFAC), and the policy is placed into “pending approval” status. After a final review and approval of the pending policy and underwriting data, the policy is placed into “active” status. In operation 125, a check for approved/active policies is sent to a designated lockbox with the application and an affidavit, wherein the check includes a unique policy ID that matches the data export. The data is queued to be exported into a policy system at 12:01 AM for policy issuance. Insured's who do not qualify for coverage are sent a letter (and returned check when applicable). In operation 130, the data is imported into the policy system.

Operation 135 involves the automatic policy issuance process, wherein the policy system automatically generates a declarations page, a cover letter, a policy form and claims instructions. In operation 140, the policy and related documents are sent to the insured via email or by other means such as via courier. Policy data is imported back into the policy system daily at 12:01 AM.

In accordance with an embodiment of the invention, insurance policy claims are handled as follows. Initially, the insured submits a claims tendering form. A regional attorney then reviews the tender and fills out a claims review form with a recommendation to either pay, deny, or reduce the claim.

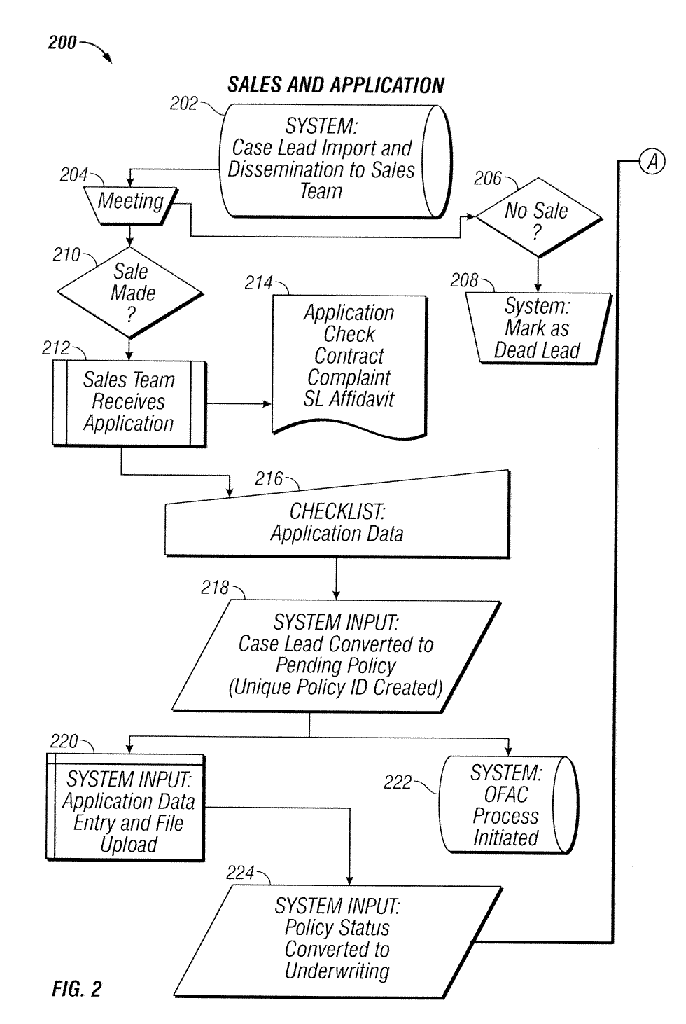

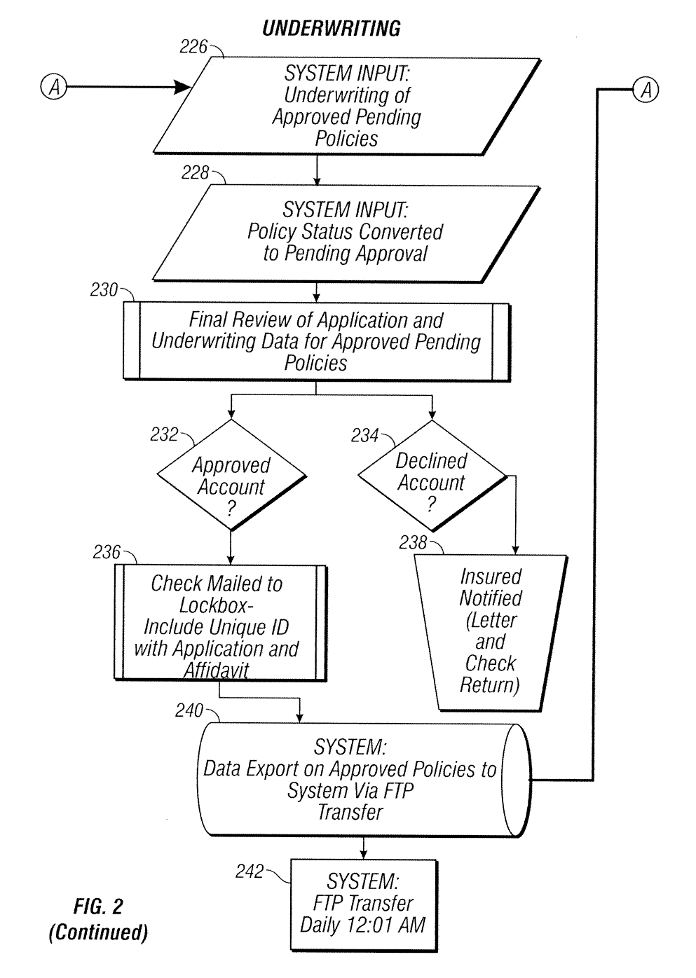

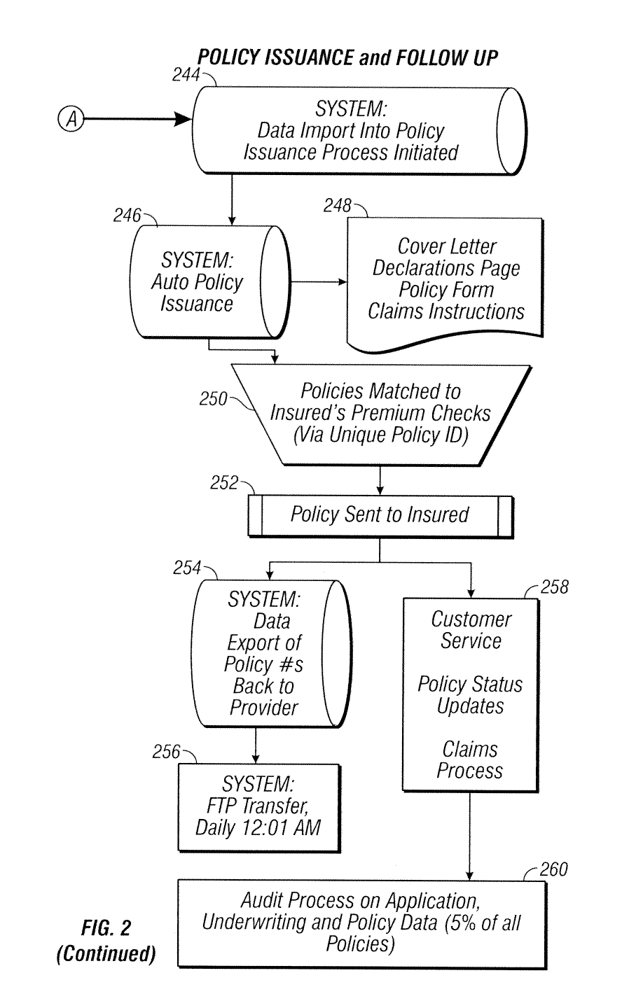

Referring to FIG. 2, a more detailed attorneys' fees insurance process flow overview 200 is illustrated. In particular, operation 202 involves the attorneys fees policy system importing case leads and disseminating the leads to one or more sales teams. In operation 204, a sales representative following a case lead optionally meets with the to be insured party. In the event of no sale (operation 206), the lead is marked in the policy system as dead (operation 208). In the event that a sale is made (operation 210), the sales team receives a policy application from the to be insured party (operation 212). Operation 214 includes the sales representative receiving the attorneys' fees insurance application, check, surplus lines affidavit, contract and complaint. In response, operation 216 involves the sales representative filling out a checklist confirming that all required items have been received. In operation 218, the sales representative converts the case lead to a pending policy and a unique policy ID is created. Operation 220 comprises the sales representative entering the insured party's application data into an attorneys' fees insurance database and uploading the application, contract and complaint. At the same time, the OFAC process is initiated in operation 222. The policy status is then converted to underwriting in operation 224.

With further reference to FIG. 2, operation 226 involves underwriting approval of pending policies. Specifically, underwriting is performed on data in the system (including OFAC), and the policy is placed into pending approval status (operation 228). Operation 230 involves a final review of the pending policy and underwriting data for approved pending policies. If the account is declined (operation 234), the insured is notified in operation 238, for example via letter enclosing the check. If the account is approved (operation 232), the policy is placed into active status, the check for approved/active policies is sent to a designated lockbox with the application and an affidavit in operation 236. In some embodiments, the check includes a unique policy ID that matches the data export. In operation 240, the data on approved policies is imported into the policy system, for example via FTP transfer. Per operation 242, the FTP transfer may occur daily at 12:01 AM).

Referring to operation 244, data is imported into the policy system and the policy issuance process is initiated. Operation 246 involves automatic policy issuance, whereas operation 248 entails the policy system automatically generating a cover letter, declarations page, policy form and claims instructions. In operation 250, policies are matched to the insured's premium checks via the unique policy ID. The policy is sent to the insured in operation 252, for example via email. In operation 254, the policy numbers are exported back to the insurance provider via FTP transfer (operation 256) daily at 12:01 AM. Operation 258 involves customer service, policy status updates and claims processing, whereas operation 260 involves an audit process on application underwriting and policy data. The audit process may entail approximately 5% of all insurance policies.

The systems of offering insurance can take many different forms. More specifically, the insurance may be offered as different types of products or policies. In accordance with some embodiments of the invention, one type of product may provide coverage if the insurance is purchased within a certain number of days after the filing of a complaint. According to this example, the insurance provides a fixed premium with a fixed amount of coverage and does not require any review of the complaint or any other document.

In accordance with further embodiments of the invention, a second product provides coverage after the initiation of a lawsuit/arbitration demand or other pleading. For this product, insurance is offered after a review of the case in order to make a determination as to whether it is financially viable for the insurer to insure the risk in the first instance and, if so, at what premium.

In accordance with additional embodiments of the invention, a third product may be offered at the time contract formation, rather than at the inception of a dispute. Since the likelihood of a dispute at this point is less imminent, this third product would offered at a reduced premium with a fixed amount of coverage. This third product may require no review of the contract itself.

In accordance with various embodiments of the invention, a fourth product is a shelf policy or “coupon book.” This product may be offered to attorneys who buy the policies in a bundle at a reduced premium and provide the insurance to their clients. The insurance belongs to the client and is a marketing tool for the law firm. The above mentioned products are just some examples of the products that may be made available through the systems and systems of offering attorneys' fees insurance. Other types of products and policies will be apparent to those skilled in the art without departing from the scope of the invention.

The insurance according to the invention may be priced based on a number of factors. One factor may be the type of product in which the insurance is embodied. For instance, as mentioned above, insurance that is offered at the onset of litigation may be priced differently than insurance offered during the discovery phase of litigation. The insurance may also be priced on the type of event, such as whether the event is litigation in Federal court, State court, the basis for the lawsuit, and the venue. The pricing may also reflect the legal counsel selected by the insured factoring in the typical cost for that firm, as well as, average fees for counsel within a particular city. The pricing may also take into consideration the type of contract, if the event is a dispute over the contract. For instance, insurance for a construction contract may be priced differently than insurance offered for a mechanic's lien dispute. The pricing would also factor in the amount of coverage desired whereby the insured can buy increments of coverage. Additional amounts of coverage may be priced lower than the base amount of coverage whereby the initial $50,000 worth of coverage may be more expensive than the second $50,000 worth of coverage.

In some embodiments, the insurance may also be priced based on the manner in which it is marketed. For instance, the shelf policy sold to attorneys would be at a reduced premium relative to insurance purchased directly from the insurer. The insurance can be priced based on how litigious the insured has been in prior actions and based on the litigation track record of their adversary The insurance can factor in the frequency by which attorneys' fees are awarded in a particular location and for a particular final adjudicator, such a particular judge. The insurance can also be priced based on the average time to judgment. In embodiments where the insured receives no payment if the dispute is settled, the insurance can be priced based on the frequency by which the insured and its adversary settle cases. Essentially any factor that influences the total amount of attorneys' fees can also be evaluated when pricing and underwriting the insurance according to the invention.

As should be apparent to those skilled in the art, the attorneys' fees insurance according to the invention has a number of unique features. For one, the insurance is offered after the occurrence of an event, such as the initiation of a lawsuit or the formation of a contract. Whereas the European Policy excludes coverage for pre-existing disputes, the attorneys' fees insurance according to the invention is designed specifically to cover such an event. The insurance systems according to the invention also cover only the risk of having to pay the adversary's attorneys' fees. The European Policy, in contrast, covers both the insured's attorneys' fees and the adversary's attorneys' fees. Unlike the European Policy, the insurance systems according to the invention allow the insured to retain control over the dispute, such as by selecting their own legal counsel, deciding whether to settle the matter, and having greater flexibility in the positions it may take in the proceedings. The insurance systems according to the invention also cover a wider range of disputes, including intellectual property cases and a greater variety of contract cases.

As set forth above, ATE insurance covers the insured's liability for their opponent's legal costs, whether that liability arises from a defeat at trial, discontinuance, or another outcome. By contrast, the insurance systems set forth herein only cover what the prevailing party provision provides. In addition, an ATE insurance premium is based upon the success of the insured such that the premium is only payable at the conclusion of the case, and only if the case is successful. On the other hand, an insurance premium based upon the systems described herein entails a one-time payment that is paid up front. ATE insurance payments may be triggered by a number of different events including settlement. In contrast, insurance payments according to the systems of the invention may only be triggered by trial or summary judgment. Moreover, unlike ATE insurance policies, the insurance systems according to the invention allow the insured to retain control over the dispute, such as by selecting their on legal counsel, deciding whether to settle the matter, and having greater flexibility in the positions it may take in the proceedings.

The insurance may be offered through an automated system. This system enables an insured to purchase coverage through a network, such as the Internet. The insured identifies the type of coverage desired, the amount of coverage, and may automatically purchase the insurance through the system. The insured, for instance, may identify or submit a copy of a contract, the desired amount of coverage being sought, and the system may return a bill for the corresponding premium to the insured. The insured may then purchase the premium on-line without the assistance of a representative for the insured. Similarly, an insured may identify pending litigation by the case number and, if the case is still in the pleading stage, may automatically purchase the insurance through the system. If the litigation has entered the discovery phase or is otherwise at a stage which requires some review, the insured may identify the case and submit a request to the insurer through the automated system and wait for a representative of the insurer to contact the insured. The automated system may be accessed through any type of data, computer, entertainment, and/or telecommunication device, such as but not limited to personal digital assistants (PDAs), mobile radiotelephones, web-enabled telephones, personal computers, WebTV or other TV products, or landline telephones. The automated system may also include a voice response system whereby an insured may call and interact with the system through voice commands and/or by depressing buttons on the keypad,

Referring to FIGS. 3-7, the attorneys' fees insurance described herein may be offered via an automated system comprising an Internet website including a plurality of web pages. More particularly, FIG. 3 depicts a case lead control web page 300 to be employed to prioritize active case leads for sales team, provide attorney contact information, as well as tracks history and next steps. In some embodiments, real-time “hot leads” may be fed to sales team. Specifically, the lead system can import case information from the different federal and state courts. The lead system outputs detailed data for all contracts shortly after (e.g., frequently within 48 hours) of those suits being initiated, the data including the name of plaintiff, the defendant, the plaintiffs attorney, and contact information for the plaintiffs attorney. Utilizing this data, the sales team (both internal and external) is able to quickly contact potential customers and, if necessary, educate them on insurance fee programs.

In certain embodiments, various strategic alliances can view the hot leads, but cannot view underwriting or claims payment dashboards. In other words, the strategic alliances are only able to view “sell-side” data. The lead system also provides transparency into the productivity of the strategic alliance (e.g., number of internal/external calls, number of incoming/outgoing calls, number of emails, meetings, win/loss rate, etc.). This information is kept current and allows the company to expand its competitive knowledge on the sales process.

Leads may be prioritized based on a number of different factors including, but not limited to the law firm, the attorney, the type of case, where it is in the pipeline, etc. This prioritization is completely automated and can be continuously revised in real-time based on actual performance. Additionally, the lead system may track risk exposure on policies sold, actual loss factors and profitability, as well as remaining exposure for the carrier. The lead system has the reporting capability to provide detailed reports that display existing policy risk exposure, loss rates in each industry and claims performance, as well as policy information.

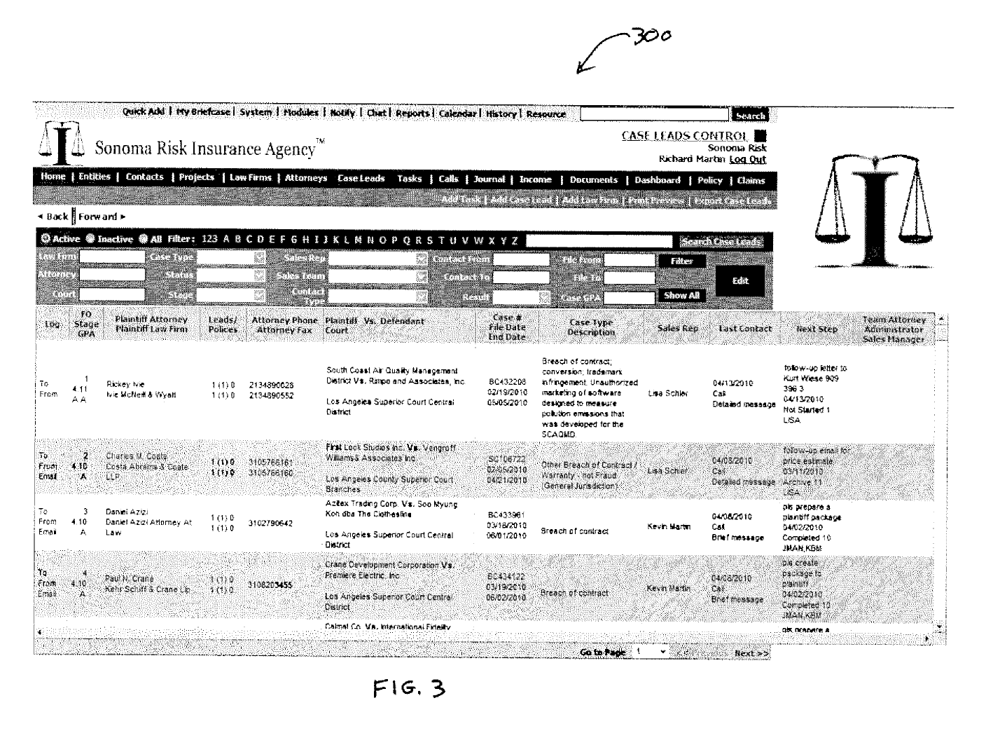

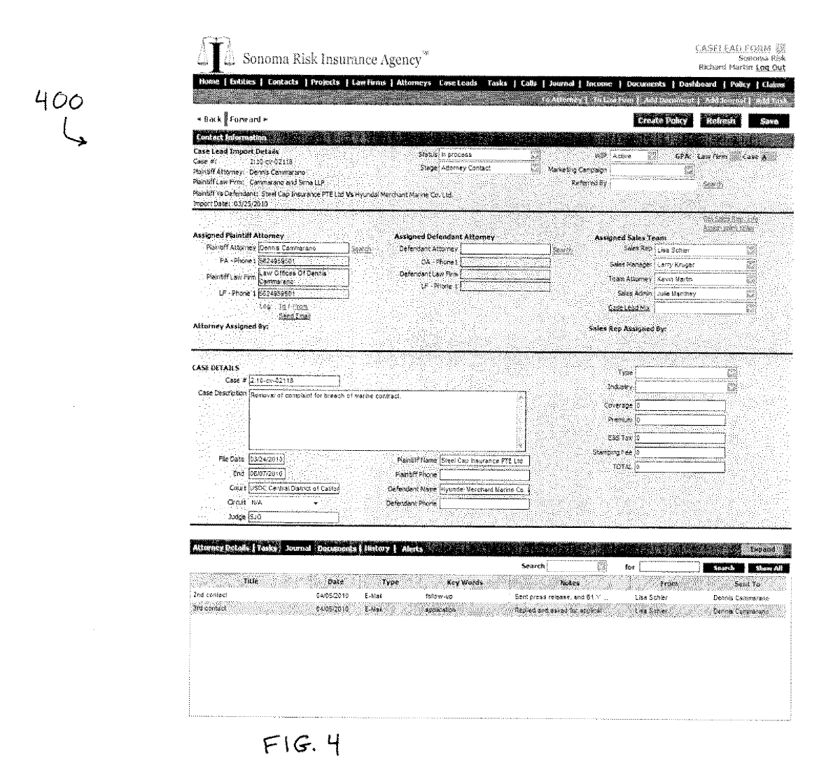

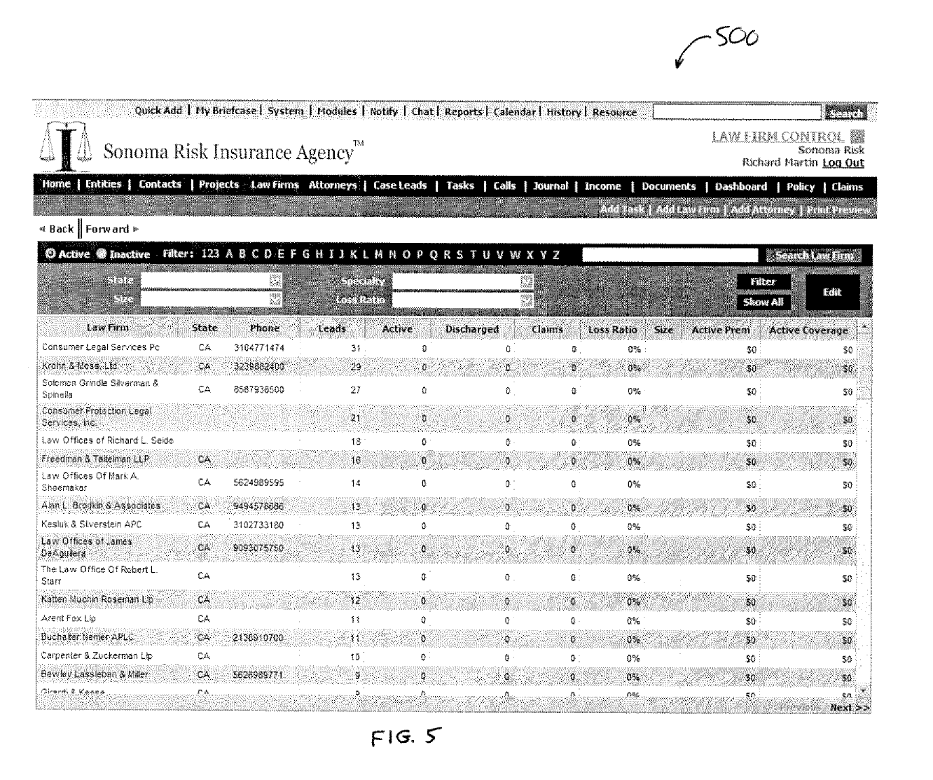

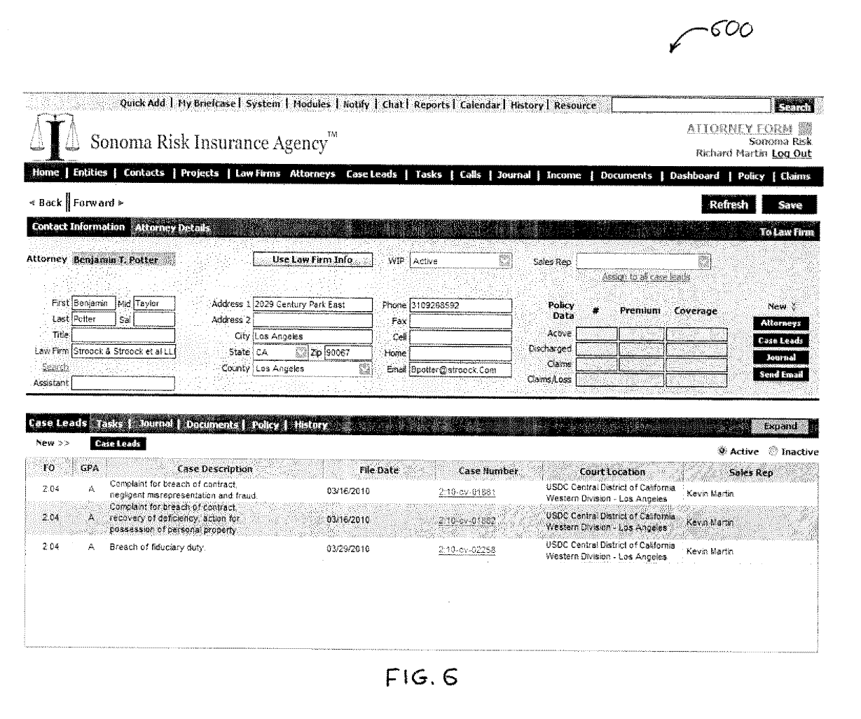

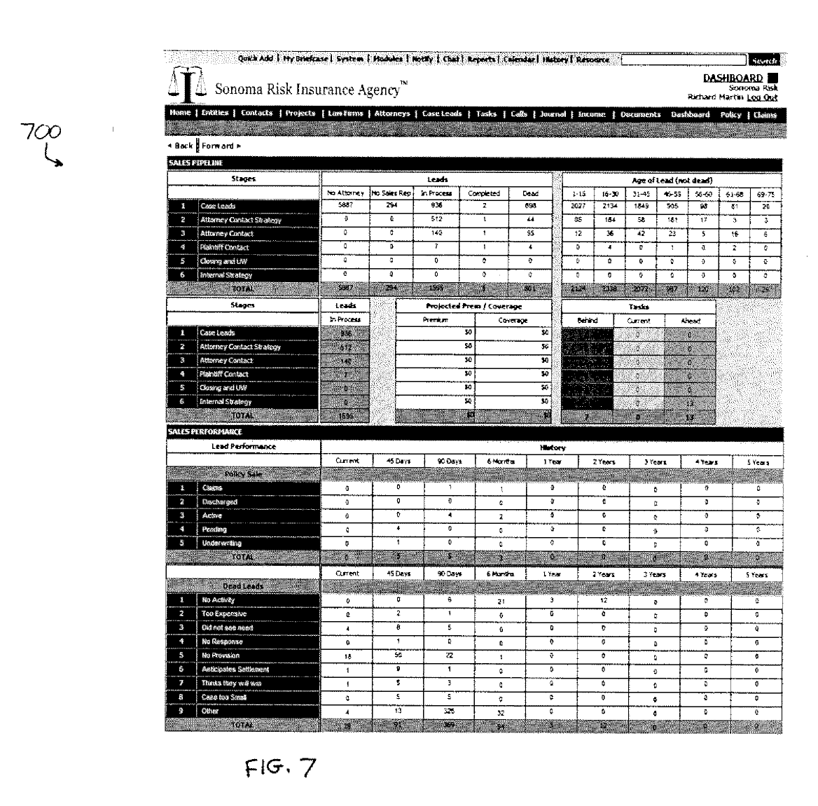

FIG. 4 illustrates a case lead form web page 400 for tracking all detail associated with a case, providing detail on all history and next steps, and tracking associated documents. FIG. 5 depicts a law firm control web page 500 that lists all law firms based on a user defined filter. In the illustrated embodiment, the user defined filter comprises the most leads by law firm. FIG. 6 illustrates an attorney form web page 600 containing detailed contact information for a specific attorney. In addition, this web page 600 tracks all open and archived case leads associated with the attorney, tracks all policies and claims associated with the attorney, and stores all history, documents and next steps. FIG. 7 depicts a dashboard web page 700 including the sales pipeline as sorted by representative and sales team. In the illustrated embodiment, the sales pipeline includes a summary of lead history, lead performance, dead leads, and claims loss ratio (not shown).

Another manner in which the insurance can be sold and distributed is by bundling the insurance with software packages. For example, a software package may provide some sample contracts for use by a lay entity, such as a small business. During use of this software, the small business can be notified of an opportunity to purchase the insurance according to the invention. The small business can be notified through a pop-up window, through a menu item, or in other ways apparent to those skilled in the art. This notification can also occur upon selection of contract language that has a clause requiring the losing party to a dispute over the contract to pay for their adversary's attorneys' fees. Additionally, rather than including the notice within the software itself, the purchasers of the software can be identified by warranty information or purchase information and the insurance can be targeted to those purchasers.

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or ply that separate hardware or software components are used to implement such features or functionality.

Where components or modules of the invention are implemented in whole or in part using software, in one embodiment, these soft are elements can be implemented to operate with a computing or processing module capable of carrying out the functionality described with respect thereto. One such example computing module is shown in FIG. 60. Various embodiments are described in terms of this example-computing module 3000. After reading this description, it will become apparent to a person skilled in the relevant art how to implement the invention using other computing modules or architectures.

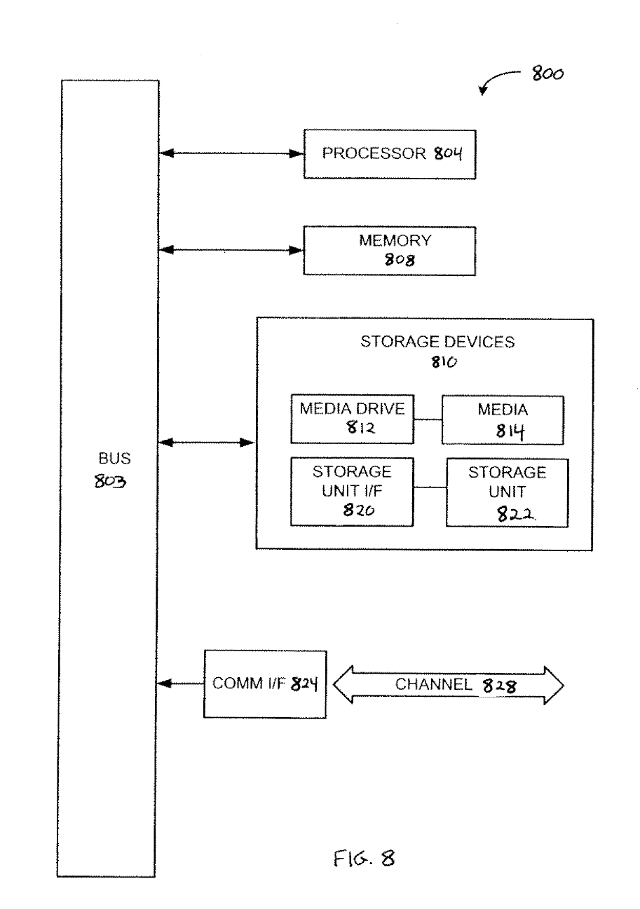

Referring now to FIG. 8, computing module 800 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interact on with other components of computing module 800 or to communicate externally.

Computing module 800 might also include one or more memory, modules, simply referred to herein as main memory 808. For example, preferably random access memory (RAM) or other dynamic memory, might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device coupled to bus 802 for storing static information and instructions for processor 804.

The computing module 800 might also include one or more various forms of information storage mechanism 810, which might include, for example, a media drive 812 and a storage unit interface 820. The media drive 3012 might include a drive or other mechanism to support fixed or removable storage media 814. For example, a hard disk drive, a floppy disk drive, a magnetic tape drive, an optical disk drive, a CD or DVD drive (R or RW), or other removable or fixed media drive might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage mechanism 810 might include other similar instrumentalities for allowing computer programs or other instructions or data to be loaded into computing module 800. Such instrumentalities might include, for example, a fixed or removable storage unit 822 and an interface 820. Examples of such storage units 822 and interfaces 820 can include a program cartridge and cartridge interface, a removable memory (for example, a flash memory or other removable memory module) and memory slot, a PCMCIA slot and card, and other fixed or removable storage units 822 and interfaces 820 that allow software and data to be transferred from the storage unit 822 to computing module 800.

Computing module 800 might also include a communications interface 824. Communications interface 824 might be used to allow software and data to be transferred between computing module 800 and external devices. Examples of communications interface 824 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 824 might typically be carried on signals, which can be electronic, electromagnetic (which includes optical) or other signals capable of being exchanged by a given communications interface 824. These signals might be provided to communications interface 824 via a channel 828. This channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 808, storage unit 820, media 814, and signals on channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise,

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. An attorneys' fees policy system, comprising:
means for importing case leads and disseminating the leads to a sales representative;
means for receiving application data of the insured party into an attorneys' fees insurance database and uploading the application, an attorneys' fee contract and a related formal legal complaint;
means for requesting underwriting approval of the attorneys' fee policy application;
means for placing the attorneys' fee policy into active status if underwriting is approved; and
means for receiving data on the approved attorneys' fee policy and initiating a policy issuance process.

2. The system of claim 1, wherein the insured party provides the sales representative with the completed attorneys' fees policy application, a check, a surplus lines affidavit, the signed attorneys' fee contract and the related legal complaint.

3. The system of claim 1, wherein the sales representative fills out a checklist confirming that all required items have been received.

4. The system of claim 1, wherein the sales representative converts the case lead to a pending policy once a sale is made and a unique policy ID is created.

5. The system of claim 1, wherein the policy is placed into pending approval status while awaiting underwriting approval.

6. The system of claim 1, wherein the policy is purchased within a predetermined number of days after the filing of the related formal legal complaint, wherein the policy provides a fixed premium with a fixed amount of coverage and does not require any review of the complaint or any other document.

7. The system of claim 1, wherein the policy is purchased after the initiation of the related legal complaint, wherein the policy is offered after a review of the related legal complaint in order to make a determination as to whether it is financially viable to insure the risk and, if so, at what premium.

8. The system of claim 1, wherein the policy is purchased before the inception of a related legal complaint, wherein the policy is offered at a reduced premium with a fixed amount of coverage.

9. The system of claim 1, wherein the policy comprises a shelf policy offered in a package at a reduced premium for an attorney to provide insurance to clients.

10. The system of claim 11, wherein the policy is priced based on factors comprising: type of product in which the policy is embodied; type of legal event; legal counsel selected by the insured; type of contract; amount of coverage desired; manner in which the policy is marketed; litigation track record of the insured and its adversary; frequency by which attorneys' fees are awarded in a particular location and for a particular final adjudicator; average time to judgment; and frequency by which the insured and its adversary settle cases.

11. The system of claim 1, wherein the policy allows the insured to select their own legal counsel for the related formal legal complaint and decide whether or not to settle the dispute.
